(19) United States
(12) Patent Application Publication
(10) Pub. No.: US 2009/0069527 A1
(43) Pub. Date: Mar. 12, 2009

(54) AIR DRYING POLYMER

(76) Inventors: Mircea Manea, Malmo (SE); Anders Clausson, Klippan (SE); Susanne Stigsson, Hassleholm (SE)

Correspondence Address: Novak, Druce & Quigg LLP, 1300 I Street, N.W., Suite 1000, West Tower, WASHINGTON, DC, 20005, US

(21) Appl. No.: 11/911,503

(22) PCT Filed: Apr. 4, 2006
(86) PCT No.: PCT/SE2006/000401

§ 371 Date: May 6, 2008

(30) Foreign Application Priority Data
Apr. 14, 2005 (SE) 0500832-1

(51) Int. Cl. C08G 63/00; C08G 65/34; C08G 18/00; C08G 59/00

(52) U.S. Cl. 528/67; 528/271; 528/425; 528/365

(57) ABSTRACT

Disclosed is a novel air drying polymer, such as an alkyd, built up from alternating air drying units and spacer units and having a general structure of R₁—R₃—(R₂—R₃); —R₁ wherein each R₁ and R₂ independently is an air drying ester or polyester unit, each R₃ independently is an ester, polyester, ether, polyether, urethane or polyurethane spacer unit which by ester and/or urethane bonding links said air drying units, n is an integer and at least 1 and wherein each R₁ and R₂ independently may be the same or different units.

The present invention refers to an air drying polymer, such as an air drying alkyd for use in for instance high solids formulations, built up from alternating air drying ester or polyester units providing autoxidative drying and ester, polyester, ether or polyether spacer units providing physical drying. In a further aspect, the present invention refers to the use of said polymer as binder and/or drying diluent in coatings.

New environmental concerns on emissions require new approaches for low VOC such as use of high solid alkyds. Current approaches for high solid alkyd resins are typically based on long oil and/or low molecular weight alkyd resins. Said current approaches typically result in a slow drying process. A major difference between conventional and high solid alkyd resins is the very slow and poor physical drying of high solid alkyds. The long term autoxidative drying compensates the lack of physical drying, however, well beyond time limits of commercial interest. Due to said poor physical drying, high solid alkyd resins, as available today, exhibit a very long time to yield dust and tack free films and too long an open time, which is a complaining issue among coating end users.

It has now quite unexpectedly been found that the physical drying of high solid alkyds can be brought to a level identical or very close to conventional alkyd resins by a change of the architecture of the alkyd binder. In this novel approach hard segments are shielded by esters or polyesters of diols, triols or polyols and drying fatty acids in a nanoscopic structure. Said nanoscopic structure replaces the laminar gliding rheology commonly acknowledged for alkyd binders with a ball bearing type of rheology. Said novel approach results in a low viscosity, a high non-volatile content and a high molecular weight imparting a strong improvement in the physical drying of the alkyd resin and a strongly reduced open time, thereby meeting the demands of the coating end users.

The present invention accordingly refers to an air drying polymer built up from alternating air drying units and spacer units and having a general structure of R₁—R₃—(R₂—R₃)ₙ—R₁ wherein each R₁ and R₂ independently is an air drying ester or polyester unit, each R₃ independently is an ester, polyester, ether or polyether spacer unit, which spacer unit by ester bonding links said air drying units, n is an integer and at least 1 and wherein each R₁ and R₂ independently may be the same or different units.

The design of the disclosed polymer structure is completely different from the commonly accepted alkyd formulations, opening for high molecular weight structures. The basic of the disclosed chemistry is the use of hard, high glass transition temperature (Tg) structures providing intense physical drying shielded by alternating air drying structures. The long fatty acid chains of said air drying units prevent the building of crystalline moieties and hydrogen bonds between the high polar spacer units.

The chain length of the spacer unit is, when the spacer unit is a crystalline unit, preferably shorter or has the same length as the fatty acid chain of the air drying unit and may have what ever length when the spacer unit has an amorphous character. Said spacer units are suitably derived from polyesters and polyethers or polyvinyls having at least 2 hydroxyl groups, such as polyacrylate diols, and are preferably linear.

The air drying polymer of the present invention is favourably produced by a first synthesis of the air drying units, followed by addition to said air drying units of carboxyl functional spacer units, for instance present as pre-synthesised polymer or produced in situ.

Each said R₁ and each said R₂ are in embodiments of the present invention independently derived from at least one ester or polyester obtained by subjecting at least one di, tri or polyhydric compound to esterification with at least one autoxidatively drying fatty acid and optionally at least one monocarboxylic acid other than said fatty acid at a molar ratio hydroxyl groups to carboxyl groups resulting in at least 1, such as at least 2, unreacted hydroxyl group.

Said di, tri or polyhydric compound is preferably a diol, triol or polyol, such as a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-hydroxyalkyl-1,3-propanediol, a 2,2-dihydroxyalkyl-1,3-propanediol or a dimer, trimer or polymer of a said 1,3-propanediol or 1,3-dioxane.

Suitable diols, triols and polyols can in various embodiments of the present invention be exemplified by for instance mono, di, tri and polyethylene glycols, mono, di, tri and polypropylene glycols, mono, di, tri and polybutylene glycols, polytetramethylene glycol, 2,2-dimethylolpropionic acid, 1,4-butanediol, 1,5-pentanediol, 1,6-hexanediol, 1,6-cyclohexanedimethanol, 5,5-dihydroxymethyl-1,3-dioxane, 2-methyl-1,3-propanediol, 2-propyl-2-methyl-1,3-propanediol, 2,2-diethyl-1,3-propanediol, 2-ethyl-2-methyl-1,3-propanediol, 2-butyl-2-ethyl-1,3-propanediol, neopentyl glycol, dimethylolpropane, 1,1-dimethylolcyclohexane, glycerol, 1,1-dimethylolnorborane, 1,1-dimethylolnorborene, trimethylolethane, trimethylolpropane, diglycerol, ditrimethylolethane, ditrimethylolpropane, pentaerythritol, dipentaerythritol, anhydroenneaheptitol, tetramethylolcyclohexanol, sorbitol and mannitol. Further embodiments of said di, tri or polyhydric compound include adducts between at least one alkylene oxide, such as ethylene oxide, propylene oxide, butylene oxide, butadiene monoxide, cyclohexene oxide and/or phenylethylene oxide, and a said di, tri or polyhydric compound.

Yet further suitable embodiments of said di, tri or polyhydric compound include hydroxyfunctional dendritic polyesters and/or polyethers, such as dendritic polymers disclosed in for instance WO 93/17060, WO 93/18079, WO 96/07688, WO 96/12754, WO 99/00439, WO 99/00440, WO 00/56802 and WO 02/40572 which disclosures in their entirety by reference is herein included, β-hydroxyamides, such as N,N′-bis(2-hydroxyethyl)adipinamide, N,N′-bis(2-hydroxylisopropyl)adipinamide or as disclosed in for instance WO 01/098257 which disclosure in its entirety by reference is herein included, hydroxyfunctional allyl ethers of for instance a said di, tri or polyhydric compound, and hydroxyfunctional carboxylic acids, such as said 2,2-dimethylolpropionic acid and for instance α,α-bis(hydroxymethyl)butyric acid, α,α,α-tris(hydroxymethyl)acetic acid, α,α-bis(hydroxymethyl)valeric acid, α,α-bis(hydroxymethyl)propionic acid, α,β-dihydroxypropionic acid, heptonic acid and 3,5-dihydroxybenzoic acid.

Said hydroxyfunctional dendritic polyester and/or polyether is in said embodiments most preferably obtained by addition of at least one di, tri or polyhydric monocarboxylic acid to a di, tri or polyhydric core molecule at a molar ratio yielding a polyhydric dendritic polymer comprising a core molecule and at least one branching generation bonded to said di, tri or polyhydric core molecule or is obtained by ring opening addition of at least one oxetane of a di, tri or polyhydric compound to a di, tri or polyhydric core molecule at a molar ratio yielding a polyhydric dendritic polymer comprising a core molecule and at least one branching generation bonded to said di, tri or polyhydric core molecule.

Said autoxidatively drying fatty acid is in embodiments of the air drying units of the present invention preferably soybean fatty acid, linseed fatty acid, tall oil fatty acid, dehydrated castor fatty acid, sunflower fatty acid, oleic acid, linoleic acid and/or linolenic acid and said optional monocarboxylic acid, other than said fatty acid, is likewise preferably abietic acid, benzoic acid, p-tert-butylbenzoic acid, caproic acid, caprylic acid and/or capric acid.

Each R₃ is in preferred embodiments of the present invention independently a polyester unit comprising sub-units from at least one diol, triol or polyol and at least one di, tri or polybasic acid or a corresponding anhydride or alkylester, such as phthalic acid/anhydride, isophthalic acid, terephthalic acid, trimellitic acid/anhydride, nadic acid/anhydride, methylnadic acid/anhydride, chlorendic acid/anhydride, naphthaline dicarboxylic acid, maleic anhydride, fumaric acid, succinic acid/anhydride, glutaric acid, adipic acid and/or itaconic acid or is an alkylester, such as a methylester, of a said acid or anhydride.

Said diol, triol or polyol is preferably a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-hydroxyalkyl-1,3-propanediol, a 2,2-dihydroxyalkyl-1,3-propanediol or a dimer, trimer or polymer of a said 1,3-propanediol or 1,3-dioxane or is an adduct between at least one alkylene oxide, such as ethylene oxide, propylene oxide, butylene oxide, butadiene monoxide, cyclohexene oxide and/or phenylethylene oxide, and a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-hydroxyalkyl-1,3-propanediol, a 2,2-dihydroxyalkyl-1,3-propanediol or a dimer, trimer or polymer of a said 1,3-propanediol or 1,3-dioxane.

Said at least diol, triol or polyol can suitably be exemplified by mono, di, tri and polyethylene glycols, mono, di, tri and polypropylene glycols, mono, di, tri and polybutylene glycols, polytetramethylene glycol, 2,2-dimethylolpropionic acid, 1,4-butanediol, 1,5-pentanediol, 1,6-hexanediol, 1,6-cyclohexanedimethanol, 5,5-dihydroxymethyl-1,3-dioxane, 2-methyl-1,3-propanediol, 2-propyl-2-methyl-1,3-propanediol, 2,2-diethyl-1,3-propanediol, 2-ethyl-2-methyl-1,3-propanediol, 2-butyl-2-ethyl-1,3-propanediol, neopentyl glycol, dimethylolpropane, 1,1-dimethylolcyclohexane, 1,1-dimethylolnorbornene, 1,1-dimethylolnorbornane, glycerol, trimethylolethane, trimethylolpropane, diglycerol, ditrimethylolethane, ditrimethylolpropane, pentaerythritol, dipentaerythritol, anhydroenneaheptitol, tetramethylolcyclohexanol, sorbitol, mannitol and adducts between at least one said alkylene oxide and a said diol, triol or polyol.

Further preferred embodiments of said at least one diol, triol or polyol include species such as polycaprolactone diols, triols and polyols obtained from a diol, triol or polyol as disclosed above and caprolactone, polyvalerolactone diols, triols and polyols obtained from a diol, triol or polyol as disclosed above and valerolactone, polycarbonate diols, triols and polyols obtained from a diol, triol or polyol as disclosed above and a carbon dioxide source, such as dimethyl carbonate, diethyl carbonate and/or urea. These macrodiols, triols and polyols preferably have a molecular weight between 400 and 2000.

In a further aspect, the present invention refers to the use of an air drying polymer, as herein disclosed, as binder and/or drying diluent, for instance partly or completely replacing commonly used organic solvents, in a coating formulation, such as a decorative and/or protective lacquer, varnish, paint or enamel.

Without further elaboration, it is believed that one skilled in the art can, using the preceding description, utilise the present invention to its fullest extent. The following preferred specific embodiments are, therefore, to be construed as merely illustrative and not limitative of the remainder of the disclosure in any way whatsoever. In the following Examples 1-7 refer to preparation of air drying polymers (alkyds) in accordance with embodiments of the present invention, Example 8 is an evaluation in an air drying lacquer of the products obtained in Examples 1-7, Example 9 is a comparative example wherein a conventional air drying alkyd is prepared and Example 10 is an evaluation of the product obtained in Example 1 as drying diluent for the product obtained in Example 9 and as sole binder in comparison with said Example 9 product.

### EXAMPLE 1

Step 1: In an autoclave equipped with nitrogen purge, Dean-Stark separator, condenser, heating system and mechanical stirring, was charged 74.91 parts of tall oil fatty acid, 16.6 parts of dipentaerythritol, 4% (on raw materials) xylene as azeotropic solvent and 0.1% (on raw materials) of esterification catalyst Fascat® 4100. The temperature was with 4° C./min raised to 160° C., subsequently increased with 1° C./min. to 220° C. and maintained until an acid value of ≈2 mg KOH/g was obtained.

Step 2: In Step 1 yielded product was cooled to 140° C. and 9.88 parts of phthalic anhydride was charged. The temperature was now raised to 160° C. to allow a controlled exothermic anhydride ring opening. 4.47 parts of 2,2-dimethylolpropionic acid was subsequently, in small portions, charged at 160° C. The temperature was now with 1° C./min. raised to 220° C. and maintained until an acid value of 15-20 mg KOH/g was reached.

Yielded product had the following characteristics:

| | |
|---|---|
| Oil length (Patton), % | 78.3 |
| Acid value, mg KOH/g | 16 |
| Hydroxyl value, mg KOH/g | 34 |
| Viscosity at 23° C., mPas | 3720 |
| Colour (Gardner) | 9.7 |

### EXAMPLE 2

Step 1: In an autoclave equipped with nitrogen purge, Dean-Stark separator, condenser, heating system and mechanical stirring, was charged 74.91 parts of sunflower fatty acid, 16.84 parts of dipentaerythritol, 4% (on raw materials) xylene as azeotropic solvent and 0.1% (on raw materials) of esterification catalyst Fascat® 4100. The temperature was with 4° C./min raised to 160° C. and subsequently increased with 1° C./min. to 220° C. The temperature 220° C. was maintained until an acid value of ≈2 mg KOH/g was obtained.

Step 2: In Step 1 yielded product was cooled to 140° C. and 9.85 parts of phthalic anhydride was charged. The temperature was now raised to 160° C. to allow a controlled exothermic anhydride ring opening. 4.47 parts of 2,2-dimethylolpropionic acid was subsequently, in small portions, charged at 160° C. The temperature was now with 1° C./min. raised to 220° C. and maintained until an acid value of 15-20 mg KOH/g was reached.

Yielded product had the following characteristics:

| | |
|---|---|
| Oil length (Patton), % | 78.3 |
| Acid value, mg KOH/g | 15 |
| Hydroxyl value, mg KOH/g | 37 |
| Viscosity at 23° C., mPas | 1670 |
| Colour (Gardner) | 8.2 |

### EXAMPLE 3

Step 1: In an autoclave equipped with nitrogen purge, Dean-Stark separator, condenser, heating system and mechanical stirring, was charged 74.98 parts of tall oil fatty acid, 16.62 parts of dipentaerythritol, 4% (on raw materials) xylene as azeotropic solvent and 0.1% (on raw materials) of esterification catalyst Fascat® 4100. The temperature was with 4° C./min. raised to 160° C., subsequently increased with 1° C./min. to 220° C. and maintained until an acid value of ≈2 mg KOH/g was obtained.

Step 2: In Step 1 yielded product was cooled to 140° C. and 5.55 parts of isophthalic acid was charged. The temperature was now raised to 220-230° C. The reaction mixture was when a clear solution was obtained cooled to 140° C. and 4.95 parts of phthalic anhydride was charged. The temperature was now raised to 160° C. to allow a controlled exothermic anhydride ring opening. 4.47 parts of 2,2-dimethylolpropionic acid was subsequently, in small portions, charged at 160° C. The temperature was now with 1° C./min. raised to 220° C. and maintained until an acid value of 15-20 mg KOH/g was reached.

Yielded product had the following characteristics:

| | |
|---|---|
| Oil length (Patton), % | 78.3 |
| Acid value, mg KOH/g | 15 |
| Hydroxyl value, mg KOH/g | 33 |
| Viscosity at 23° C., mPas | 2550 |
| Colour (Gardner) | 8.2 |

### EXAMPLE 4

Step 1: In an autoclave equipped with nitrogen purge, Dean-Stark separator, condenser, heating system and mechanical stirring, was charged 86.24 parts of tall oil fatty acid, 19.1 parts of dipentaerythritol and 4% (on raw materials) of xylene as azeotropic solvent. The temperature was during 2-3 hours raised to 220° C. and maintained until an acid value of less than 3 mg KOH/g was obtained.

Step 2: In an autoclave equipped with nitrogen purge, Dean-Stark separator, condenser, heating system and mechanical stirring, was charged 69.9 parts of neopentyl glycol and 32.75 parts of phthalic anhydride. The temperature was raised to 200° C. and maintained until an acid value of less than 185 mg KOH/g was obtained.

Step 3: In an autoclave equipped with nitrogen purge, Dean-Stark separator, condenser, heating system and mechanical stirring, was charged 81.65 parts of the product obtained in Step 1, 4% (on raw materials) of xylene as azeotropic solvent and under stirring 18.35 parts of product obtained in Step 2. The temperature was raised to 200° C. and maintained until an acid value of 10±1 mg KOH/g was obtained.

### EXAMPLE 5

Step 1: In an autoclave equipped with nitrogen purge, Dean-Stark separator, condenser, heating system and mechanical stirring, was charged 73.83 parts of tall oil fatty acid, 10.47 parts of benzoic acid, 21.87 parts of dipentaerythritol and 4% (on raw materials) of xylene as azeotropic solvent. The temperature was during 2-3 hours raised to 220° C. and maintained until an acid value of less than 3 mg KOH/g was obtained.

Step 2: In an autoclave equipped with nitrogen purge, Dean-Stark separator, condenser, heating system and mechanical stirring, was charged 69.9 parts of neopentyl glycol and 32.75 parts of phthalic anhydride. The temperature was raised to 200° C. and maintained until an acid value of 185 mg KOH/g was obtained.

Step 3: In an autoclave equipped with nitrogen purge, Dean-Stark separator, condenser, heating system and mechanical stirring, was charged 80.52 parts of the product obtained in Step 1 and under stirring 19.42 parts of product obtained in Step 2. The temperature was raised to 200° C. and maintained until an acid value of 10±1 mg KOH/g was obtained.

### EXAMPLE 6

Step 1: In an autoclave equipped with nitrogen purge, Dean-Stark separator, condenser, heating system and mechanical stirring, was charged 86.24 parts of tall oil fatty acid, 19.1 parts of dipentaerythritol and 4% (on raw materials) of xylene as azeotropic solvent. The temperature was during 2-3 hours raised to 220° C. and maintained until an acid value of less than 3 mg KOH/g was obtained.

Step 2: In an autoclave equipped with nitrogen purge, Dean-Stark separator, condenser, heating system and mechanical stirring, was charged 66.02 parts of neopentyl glycol and 39.72 parts of phthalic anhydride. The temperature was raised to 200° C. and maintained until an acid value of 70 mg KOH/g was obtained.

Step 3: In an autoclave equipped with nitrogen purge, Dean-Stark separator, condenser, heating system and mechanical stirring, was charged 87.20 parts of the product obtained in Step 1, 4% (on raw materials) of xylene as azeotropic solvent and under stirring 12.80 parts of product obtained in Step 2. The temperature was raised to 200° C. and maintained until an acid value of 10±1 mg KOH/g was obtained.

### EXAMPLE 7

Step 1: In an autoclave equipped with nitrogen purge, Dean-Stark separator, condenser, heating system and mechanical stirring, was charged 86.24 parts of tall oil fatty acid, 19.10 parts of dipentaerythritol and 4% (on raw materials) of xylene as azeotropic solvent. The temperature was during 2-3 hours raised to 220° C. and maintained until an acid value of less than 3 mg KOH/g was obtained.

Step 2: In an autoclave equipped with nitrogen purge, Dean-Stark separator, condenser, heating system and mechanical stirring, was charged 66.02 parts of neopentyl glycol. 39.72 parts of phthalic anhydride. The temperature was raised to 200° C. and maintained until an acid value of 70 mg KOH/g was obtained.

Step 3: In an autoclave equipped with nitrogen purge, Dean-Stark separator, condenser, heating system and mechanical stirring, was charged 77.88 parts of the product obtained in Step 1, 4% (on raw materials) of xylene as azeotropic solvent and under stirring 22.12 parts of product obtained in Step 2. The temperature was raised to 200° C. and maintained until an acid value of 10±1 mg KOH/g was obtained.

### EXAMPLE 8

Clear coatings were prepared using the products obtained in Examples 1-7. Said products were diluted to a 90% non-volatile content in white spirit and 2% by weight of zirkonium octoate (12% Zr), 0.55% by weight of cobalt octoate (10% Co), 0.95% by weight of calcium octoate (10% Ca) and 0.10% by weight of an antiskin additive were admixed. Obtained lacquers were applied on glass panels at a film thickness of 30-35 μm (dry) and the drying properties were recorded as time to dust dry, tack free and through dry.

### Result:

| Example | 1 | 2 | 3 | 4 | 5 | 6 | 7 |
|---|---|---|---|---|---|---|---|
| Dust dry, hours | 2.5 | 2 | 2 | 3 | 7 | 5 | 6.5 |
| Tack free, hours | 4 | 3 | 3 | 5.5 | 18 | 6.5 | 8 |
| Through dry, hours | 24 | 19 | 16.5 | 8.5 | 24 | 11 | 24 |

### EXAMPLE 9

### Comparative

A conventional air drying alkyd was prepared by charging 62.21 parts of tall oil fatty acid, 20.42 parts of pentaerythritol, 23.88 parts of phthalic anhydride, 4% (on raw materials) of xylene as azeotropic solvent and 0.1% (on raw materials) of esterification catalyst Fascat 4100 in an autoclave equipped with nitrogen purge, Dean-Stark separator, condenser, heating system and mechanical stirring. The temperature was during 3-4 hours raised to 235° C., subsequently increased with 1° C./min to 220° C. and maintained until an acid value of 10±1 mg KOH/g was obtained. Yielded product was cooled and diluted in white spirit to a non-volatile content of 75%.

Yielded product had the following characteristics:

| | |
|---|---|
| Oil length (Pattern), % | 65 |
| Acid value, mg KOH/g | 10 |
| Hydroxyl value, mg KOH/g | 43 |
| Viscosity (60%) at 23° C., mPas | 2550 |
| Colour (75%), Gardner | 6.4 |

### EXAMPLE 10

Clear coatings were prepared using the product obtained in Example 1 as sole binder and as co-binder (drying diluent) to the product (conventional air drying alkyd) obtained in Example 9 (Comparative) at a weight ratio product according to Example 1 to product according to Example 9 of 70:30, 50:50 and 30:70. The product obtained in Example 9 was furthermore uses as sole binder in a reference coating. Said products were diluted with white spirit to a viscosity of 450-500 mPas and 2% by weight of zirkonium octoate (12% Zr), 0.55% by weight of cobalt octoate (10% Co), 0.95% by weight of calcium octoate (10% Ca) and 0.10% by weight of an antiskin additive were admixed. Obtained lacquers were applied on glass panels at a film thickness of 20-25 μm (dry) and the drying properties were recorded as time to dust dry, tack free and through dry.

### Result:

| | | | | | |
|---|---|---|---|---|---|
| Product acc. Example 1 | 100 | 70 | 50 | 30 | — |
| Product acc. Example 9 (Comp.) | — | 30 | 50 | 70 | 100 |
| Non-volatile content, % | 80.4 | 75.4 | 71.0 | 65.6 | 58.3 |
| Dust dry, hours | 1.5 | 1.5 | 1 | 1 | 1 |
| Tack free, hours | 2.5 | 2.5 | 2 | 2 | 1.5 |
| Through dry, hours | 8 | 5 | 6.5 | 5.5 | 5.5 |

1. An air drying polymer characterised in, that it is built up from alternating air drying units and spacer units and has general structure of R₁—R₃(R₂—R₃)_{η}—R₁ wherein each R₁ and R₂ independently is an air drying ester or polyester unit, each R₃ independently is an ester, polyester, ether, polyether, urethane or polyurethane spacer unit which by ester and/or urethane bonding links said air drying units and wherein η is an integer and at least 1.

2. An air drying polymer according to claim 1 characterized in, that each R₁ independently is derived from at least one ester or polyester obtained by subjecting at least one di, tri or polyhydric compound to esterification with at least one autoxidatively drying fatty acid and optionally at least one monocarboxylic acid other than said fatty acid at a molar ratio hydroxyl groups to carboxyl groups resulting in at least 1, such as at least 2, unreacted hydroxyl group.

3. An air drying polymer according to claim 1 characterised in, that each R₂ independently is derived from at least one ester or polyester obtained by subjecting at least one di, tri or polyhydric compound to esterification with at least one autoxidatively drying fatty acid and optionally at least one monocarboxylic acid other than said fatty acid at a molar ratio hydroxyl groups to carboxyl groups resulting in at least 2 unreacted hydroxyl groups.

4. An air drying polymer according to claim 2 characterised in, that said di, tri or polyhydric compound is a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-2hydroxyalkyl-1,3-propanediol, a 2,2,-dihydroxyalkyl-1,3-propanediol or a dimmer, trimer or polymer of a said, 1,3-propanediol or 1,3-dioxane.

5. An air drying polymer according to claim 2 characterised in, that said di, tri or polyhydric compound is an adduct between at least one alkylene oxide and a 5,5-hydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propandiol, a 2,2-dialkyl-1,3-propanediol, a 2-alkyl-2-hydroxyalkyl-1,3,-propanediol, a 2,2-dihydroxy-alkyl-1,3-propanediol or a dimmer, trimer or polymer of a said 1,3-propanediol or 1,3-dioxane.

6. An air drying polymer according to claim 2 characterised in, that said di, tri or polyhydric compound is a mono, di, tri or polyethylene glycol, a mono, di tri or polypropylene glycol, a mono, di, tri or polybutylene glycol, polytetramethylene glycol, 2,2-dimethylolpropionic acid, 1,4-butanediol, 1,5-pentanediol, 1,6-hexanediol, 1,6-cyclohexanedimethanol, 5,5-dihydroxymethyl-1,3-dioxane, 2-methyl-1,3-propanediol, 2-propyl-2-methyl-1,3-propanediol, 2,2-diethyl-1,3-propanediol, 2-ethyl-2-methyl-1,3-propanediol, 2-butyl-2-ethyl-1,3-propanediol, neopentyl glycol, dimethylolpropane, 1,1-dimethylolcyclohexane, glycerol, 1,1-dimethylolnorborane, 1,1-dimethylolnorborene, trimethylolethane, trimethylolpropane, digylcerol, ditrimethylolethane, ditrimethylolpropane, pentaerythritol, dipentaerythritol, anhydroenneaheptitol, tetramethylolcyclohexanol, sorbitol, mannitol or an adduct between at least one alkylene oxide and a said di, tri or polyhydric compound.

7. An air drying polymer according to claim 5 characterised in, that said alkylene oxide is ethylene oxide, propylene oxide, butylenes oxide, butadiene monoxide, cyclohexene oxide and/or phenylethylene oxide.

8. An air drying polymer according to claim 2 characterised in, that said di, tri or polyhydric compound is a hydroxyfunctional allyl ether of a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-hydroxyalkyl-1,3-propanediol, a 2,2-dihydroxyalkyl-1,3-propanediol or a dimmer, trimer or polymer of a said 1,3-propanediol or 1,3-dioxane.

9. An air drying polymer according to claim 2 characterised in, that said di, tri or polyhydric compound is a hydroxyfunctional dendritic polyester and/or polyether.

10. An air drying polymer according to claim 2 characterised in, that said di, tri or polyhydric compound is a β-hydroxyamide.

11. An air drying polymer according to claim 2 characterised in, that said fatty acid is soybean fatty acid, linseed fatty acid, tall oil fatty acid, dehydrated castor fatty acid, sunflower fatty acid, oleic acid, linoleic acid and/or linolenic acid.

12. An air drying polymer according to claim 2 characterised in, that said optional monocarboxylic acid is abietic acid, benzoic acid, p-tent-butylbenzoic acid, caproic acid, caprylic acid and/or capric acid.

13. An air drying polymer according to claim 2 characterised in, that each R₃ independently is a polyester unit comprising subunits from at least one diol, triol or polyol and at least one di, tri or polybasic acid or a corresponding anhydride or alkylester.

14. An air drying polymer according to claim 13 characterised in, that said di, tri or polybasic acid, anhydride or alkylester is phthalic acid, phthalic anhydride, isophthalic acid, terephthalic acid, trimellitic acid, trimellitic anhydride, nadic anhydride, nadic acid, methylnadic anhydride, methylnadic acid, chlorendic anhydride, chlorendic acid, naphthaline dicarboxylic acid, maleic anhydride, fumaric acid, succinic acid, succinic anhydride, glutaric acid, adipic acid and/or itaconic acid or is an alkylester, such as a methylester, of a said acid or anhydride.

15. An air drying polymer according to claim 13 characterised in, that said at least one diol, triol or polyol is a polycaprolactone diol, triol or polyol obtained from a diol, triol or polyol and caprolactone.

16. An air drying polymer according to claim 13 characterised in, that said at least one diol, triol or polyol is a polyvalerolactone diol, triol or polyol obtained from a diol, triol or polyol and valerolactone.

17. An air drying polymer according to claim 13 characterised in, that said at least one diol, triol or polyol is a polycarbonate diol, triol or polyol obtained from a diol, triol or polyol and a carbon dioxide source.

18. An air drying polymer according to claim 17 characterised in, that said carbon dioxide source is dimethyl carbonate, diethyl carbonate and/or urea.

19. An air drying polymer according to claim 13 characterised in, that said at least one diol, triol or polyol is a hydroxyfunctional allyl ether or a diol, triol or polyol.

20. An air drying polymer according to claim 13 characterised in, that said diol, trio or polyol is a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-hydroxyalkyl-1,3-propanediol, a 2,2-dihydroxyalkyl-1,3-propanediol or a dimer, trimer or polymer of a said 1,3-propanediol or 1,3-dioxane.

21. An air drying polymer according to claim 13 characterised in, that said diol, triol or polyol is an adduct between at least one alkylene oxide and a 5,5-dihydroxyalkyl-1,3-dioxane, a 2-carboxy-2-alkyl-1,3-propanediol, a 2-hydroxy-1,3-propanediol, a 2-hydroxy-2-alkyl-1,3-propanediol, a 2-alkyl-1,3-propanediol, a 2,2-dialkyl-1,3-propanediol, a 2-alkyl-2-hydroxyalkyl-1,3-propanediol, a 2,2-dihydroxyalkyl-1,3-propanediol or a dimer, trimer or polymer of a said 1,3-propanediol or 1,3-dioxane.

22. An air drying polymer according to claim 13 characterised in, that said at least diol, triol or polyol is a mono, di, tri or polyethylene glycol, a mono, di, tri or polypropylene glycol, mono, di, tri or polybutylene glycol, polytetramethylene glycol, 2,2-dimethylolpropionic acid, 1,4-butanediol, 1,5-pentanediol, 1,6-hexanediol, 1,6-cyclohexanedimethanol, 5,5-dihydroxymethyl-1,3-dioxane, 2-methyl-1,3-propanediol, 2-propyl-2-methyl-1,3-propanediol, 2,2-diethyl-1,3-propanediol, 2-ethyl-2-methyl-1,3-propanediol, 2-butyl-2-ethyl-1,3-propanediol, neopentyl glycol, dimethylolpropane, 1,1-dimethylolcyclohexane, 1,1-dimethylolnorbornene, 1,1-dimethylolnorbornane, glycerol, trimethylolethane, trimethylolpropane, diglycerol, ditrimethylolethane, ditrimethylolpropane, pentaerythritol, dipentaerythritol, anhydroenneaheptitol, tetramethylolcyclohexanol, sorbitol, mannitol or an adduct between at least one alkylene oxide and a said diol, triol or polyol.

23. An air drying polymer according to claim 21 characterised in, that said alkylene oxide is ethylene oxide, propylene oxide, butylenes oxide, butadiene monoxide, cyclohexene oxide and/or phenylethylene oxide.

24. Use of an air drying polymer according to claim 1, as binder, co-binder and/or drying diluent in a coating formulation, such as a decorative and/or protective lacquer, varnish, paint or enamel.
